(19) United States
(12) Patent Application Publication
(10) Pub. No.: US 2021/0208043 A1
(43) Pub. Date: Jul. 8, 2021

(54) A DENSIMETER

(71) Applicant: AREADERMA S.R.L., PERGINE VALSUGANA (Trento) (IT)

(72) Inventors: Massimo STROPPARI, PERGINE VALSUGANA (Trento) (IT); Giacomo PROSDOCIMO, Castelfranco Veneto (Treviso) (IT)

(21) Appl. No.: 17/058,706

(22) PCT Filed: May 15, 2019
(86) PCT No.: PCT/IB2019/054024

§ 371 Date: Nov. 25, 2020

(30) Foreign Application Priority Data
May 28, 2018 (IT) 102018000005789

(51) Int. Cl. G01N 9/04

(52) U.S. Cl. CPC G01N 9/04

(57) ABSTRACT

A densimeter is provided including a tank defining a storage volume; a liquid partially filling the storage volume; a scale suitable to measure the mass of the tank; a level indicator partially immersed in the liquid and suitable to detect a change in height of the liquid; a control unit suitable to determine the density of a sample in the liquid based on a change in mass of the tank measured by the scale and a change in height of the liquid measured by the level indicator.

The present invention relates to a densimeter of the type as recited in the preamble of the first claim.

It is suitable for measuring the density or weight density of a cream, solid or other similar sample. It should be noted that in this document density or weight density, varying from density by gravity only, will for the sake of simplicity be uniquely identified by the term “density” (in the same way weight and mass will for simplicity be uniquely identified by the term “mass”).

As is known, the density measurement of a sample is based on the knowledge of the mass and volume of the sample.

To calculate the mass of the sample, the operator places the sample on a scale and reads off its mass.

To obtain the volume of the sample, the operator places the sample in a graduated container containing a liquid and reads on the graduation the increase in height of the liquid to obtain the volume of the sample. Alternatively, a container having a known volume (pycnometer) may be used, by filling it with the substance the density of which is to be measured.

The prior art described has several significant drawbacks.

In particular, the reading of the mass and especially of the variation in height of the liquid is not particularly accurate and leads to significant errors in the density measurement. The use of a container of known volume also leads to inaccuracies due to the difficulty of filling the volume correctly without incorporating pockets of air.

These measurement errors, in addition to being due to an inaccuracy of the very instruments used (for example in the reading of the graduated scale on the container), are determined by other aspects such as the surface tension of the liquid which, causing irregular curves of the liquid at the perimeter of the container, prevents a correct reading of the level. The use of a container of known volume is also not free of errors due both to the difficulty of ensuring that the volume is perfectly filled and to the dimensional tolerances of the container itself.

It should be noted that on account of this drawback, in order to reduce the error and thus have a more accurate density measurement, the entire measurement process needs to be repeated several times for each sample.

Another drawback is the slowness of the measurement process with the prior instruments. For example, after immersing the sample it is necessary to wait for the liquid to return to a still state.

The aforementioned drawbacks lead to high density measurement costs, especially when related to poor measurement accuracy.

In this situation the technical purpose of the present invention is to devise a densimeter able to substantially overcome at least some of the drawbacks mentioned.

Within the sphere of said technical purpose one important aim of the invention is to provide a densimeter which is simple, fast to use and, especially, highly accurate. The technical purpose and specified aims are achieved by a densimeter as claimed in the appended claim 1. Examples of preferred embodiments are described in the dependent claims.

The characteristics and advantages of the invention are clearly evident from the following detailed description of preferred embodiments thereof, with reference to the accompanying drawings, in which:

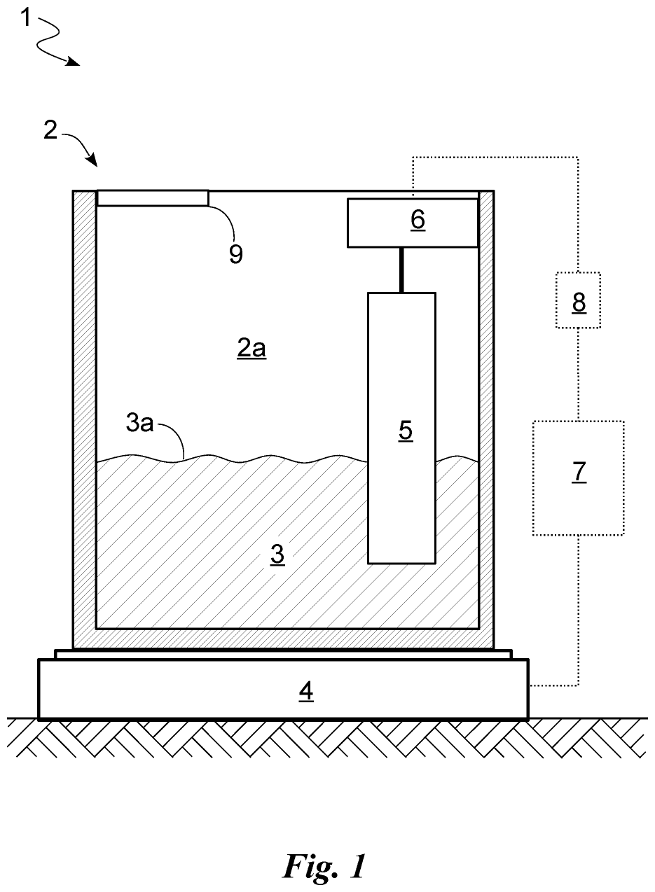

FIG. 1 shows a densimeter according to the invention; and

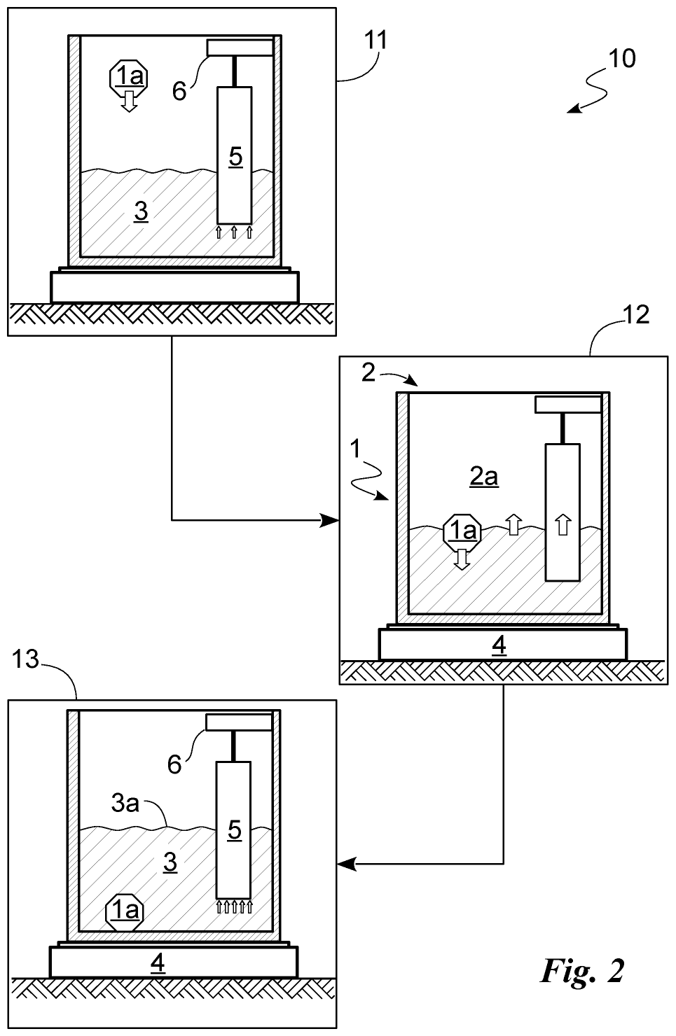

FIG. 2 shows how the densimeter according to the invention is used.

Herein the measures, values, shapes and geometric references (such as perpendicularity and parallelism), when used with words like “about” or other similar terms such as “approximately” or “substantially”, are to be understood as except for measurement errors or inaccuracies due to production and/or manufacturing errors and, above all, except for a slight divergence from the value, measure, shape or geometric reference which it is associated with. For example, said terms, if associated with a value, preferably indicate a divergence of not more than 10% of said value.

In addition, when used, terms such as “first”, “second”, “upper”, “lower”, “main” and “secondary” do not necessarily refer to an order, a priority relationship or relative position, but may simply be used to more clearly distinguish different components from each other.

The measurements and data presented herein are to be considered, unless otherwise indicated, as made in ICAO Standard International Atmosphere (ISO 2533).

Unless otherwise specified, as is apparent from the following discussions, it is considered that terms such as “processing”, “computer science”, “determination”, “calculation” or similar, refer to the computer action and/or processes or similar electronic computing devices that manipulate and/or transform data represented as physical, such as electronic quantities of registers of an information system and/or memory, other data similarly represented as physical quantities within computer systems, registers or other devices for storing, transmitting or displaying information. With reference to the Drawings, reference numeral 1 globally denotes the densimeter according to the invention.

It is suitable for measuring the density of a sample 1a of an object the density of which is to be measured. The sample 1a may be solid or preferably a cream and/or a liquid.

The weight and/or volume of the sample 1a need not be known and preferably neither the weight or the volume since they are irrelevant in the density calculation with the densimeter 1.

The densimeter 1 comprises a tank 2 defining a storage volume 2a and preferably a bottom surface of said volume 2a; and a liquid 3 partially filling said storage volume 2a.

The storage volume 2a defines a longitudinal axis, suitably parallel to the gravitational gradient or alternatively inclined with respect to the gravitational gradient by a known angle of inclination.

The storage volume 2a may be of any capacity since it does not influence the density calculation with the densimeter 1.

The storage volume 2a has a constant cross-section along the longitudinal axis. Alternatively, the cross-section of the storage volume 2a may vary along the longitudinal axis with known function.

The volume and weight of the liquid 3 introduced into the storage volume may be any since they do not influence the density calculation with the densimeter 1. In detail, the volume of liquid 3 must be such as to fully submerge the sample 1a. The liquid 3 may exhibit reduced volatility. In detail, the liquid 3 has a surface tension of less than 100 torr and, to be precise, 50 torr.

The liquid 3 may have a low dynamic viscosity. In detail, the viscosity coefficient, measured by viscometer, of the liquid 3 is less than 10000 cP, suitably 5000 cP, in detail 1000 cP and to be precise 100 cP and more precisely 1 cP.

The liquid 3 has a density ρₗ lower than the density ρₒ of the sample 1a. It may be water, hydrocarbon or another liquid. To be precise, the density of the liquid pi may be substantially less than 2 and preferably 1 g/cm³. In particular it may be substantially less than 0.9 g/cm³ and, for example, the liquid 3 may be Vaseline (density 0.84 g/cm³). More particularly, the density of the liquid pi may be substantially less than 0.8 g/cm³ and, for example, the liquid 3 may be pentane (density 0.76 g/cm³). More particularly yet, the density of the liquid pi may be substantially 0.6 g/cm³ and suitably the liquid 3 may be a gel (density 0.6 g/cm³). The densimeter 1 comprises a scale 4 suitable to measure the mass of the tank 2, i.e. the tank 2 and its contents (liquid 3, sample 1a, etc.).

The scale 4 has an accuracy of at least 0.01 g.

The densimeter 1 comprises a level indicator 5 partially immersed in the liquid 3; and suitably a measuring element 6 of said variation in height of the liquid 3.

The indicator 5 has, regardless of the presence of the sample 1a in the liquid 3, a portion not immersed in the liquid 3. It thus defines a portion immersed in the liquid 3 and a portion emerged from the liquid 3 optionally at least partially protruding from the storage volume 2a.

The level indicator 5 defines an additional longitudinal axis.

The additional longitudinal axis may be parallel to the gravitational gradient or alternatively inclined with respect to the gravitational gradient by a known additional angle of inclination.

The additional longitudinal axis may be parallel to the longitudinal axis of the volume 2a.

The indicator 5 has a constant cross-section along the additional longitudinal axis.

Alternatively, the cross-section of the level indicator 5 may vary along the additional longitudinal axis with known function.

The ratio between the sections, calculated along the additional longitudinal axis, of the level indicator 5 and the storage volume 2a is at least 1/20, in detail 1/6, more in detail 1/3 and preferably 1/2 and more preferably 3/4.

The free surface of the liquid 3a, defined as the difference between the sections, calculated along the additional longitudinal axis, of the storage volume 2a and the level indicator 5, has an adequate surface and geometry for the insertion of the sample 1a. It can be at least equal to 2 and in detail to 5 cm².

The level indicator 5 is not in contact with the bottom surface of the volume 2a and preferably with the sample 1a in the tank 2.

The indicator 5 is suitable to detect the volume of the sample 1a introduced based on a change in the height of the liquid 3 in the tank 2.

In detail it is suitable to measure a change in height of the liquid 3 directly or preferably indirectly.

In the first case, i.e. direct measurement of the change in height of the liquid 3, the level indicator 5, when the product 1a is inserted in the liquid 3, moves with respect to the tank 2 leaving the immersed and emerged portions substantially unchanged. The height variation of liquid 3 is the vertical displacement, i.e. along the gravitational gradient, of the level indicator 5. In this case the indicator 5 is a float.

In this case, the measuring element 6 is suitable to measure the vertical displacement of the level indicator 5 thus measuring the change in height of the liquid 3. It may be optical or another device capable of measuring such vertical displacement of the level indicator 5.

In the preferred alternative of indirect measurement of the change in height of the liquid 3, the level indicator 5, upon insertion of the sample 1a, suitably of unknown volume and weight, in the liquid 3, remains almost stationary increasing the immersed portion proportionally to the change in height of the liquid 3 in the tank 2. This variation of the immersed portion determines a proportional pressure variation on the level indicator 5 which, detected by the measuring element 6, allows said variation in the height of the liquid 3 to be obtained.

In this preferred alternative the level indicator 5 is integral with the tank 2.

In this case the measuring element 6 comprises a load cell or other similar device suitable to detect said pressure variation on the level indicator 5.

The densimeter 1 comprises a control unit 7 suitable to determine the density of the sample 1a in the liquid 3 as a function of a change in mass of the tank 2 measured by the scale 4 and of the volume of the sample 1a measured as a function of the change in height of the liquid.

The mass variation of the tank 2 measured by the scale 4 identifies the mass, in the case of density, and the weight, in the case of weight density, of the sample 1a added, suitably of unknown weight and volume.

The change in height of the liquid 3, suitably measured directly or preferably indirectly, identifies the volume of sample 1a added based on the cross-section of the storage volume 2a and the level indicator 5.

In particular in the case of direct measurement, the control unit 7 is suitable to determine the volume of the sample 1a as a function of the vertical displacement of the level indicator 5 measured by the measuring element 6.

In the case of indirect measurement, the control unit 7 is suitable to determine the volume of the sample 1a as a function of the pressure change on the level indicator 5 measured by the measuring element 6.

In the case of indirect measurement of the change in height of the liquid 3, the control unit 7 identifies the density ρₒ of the sample 1a according to the formula:

$${ρ}_{o} = \frac{{m}_{o} \times {ρ}_{l} \times {S}_{G}}{Δ F ( {S}_{V} - {S}_{G} )}$$

where mₒ is the mass of the sample 1a; ΔF is the change in thrust on the level indicator 5; and S_{V} and S_{G} are the cross-section of the volume 2a and the level indicator 5 respectively.

It is to be noted that if the level indicator 5 and/or storage volume 2a have a non-constant cross-section S_{V} and S_{G} identify the variation functions of the corresponding cross-section. These functions can then be stored in the control unit 7.

The densimeter 1 may comprise a clock 8 suitable to detect a non-insertion period as the time interval between subsequent sample 1a insertions.

Said clock 8 is suitable to detect the non-insertion period as the time elapsed between the measurement of the weight change and/or height of the liquid 3.

The densimeter 1 may include a detector 9 suitable to detect the introduction of a sample 1a into the storage volume 2a and thus into the liquid 3.

The detector 9 may be a photocell or other similar instrument positioned at the input section of the volume 2a so as to detect the passage of a sample through said section.

Preferably the input section of the volume 2a is divided, suitably by means of a divider, into a first input area and a second input area and the detector 9 detects the passage of a sample through only the first input area so as not to detect the input of samples 1a through the second input area.

The densimeter 1 may comprise a densimeter-user interface.

The densimeter-user interface may comprise input means (e.g., a keyboard) suitable to allow an operator to enter data into the densimeter 1.

The densimeter-user interface may comprise output means (e.g., a screen, preferably touch) that allow the densimeter 1 to display data, such as the sample 1a density, to an operator.

Finally, it should be noted that the control unit 7 may be suitable to determine the density of one or more additional samples inserted without removing the previous samples.

Preferably, the control unit 7 may determine a possible density change of one or more additional samples the same as sample 1a; and/or determine the density of an additional sample different from the sample 1a.

In detail, if the clock 8 detects a period of non-insertion substantially at least equal to a time threshold, the control unit 7 resets the previously determined weight and height variations (i.e. relative to sample 1a) and determines the density of the additional sample only by using only the mass and height variations following the insertion of the additional sample. If the clock 8 detects a non-insertion period substantially below a time threshold, the control unit 7 does not reset the previously determined weight and height variations and determines the density of the sample 1a and the additional sample(s) subsequently introduced based on all previously calculated variations.

The time threshold may be 60″. It should be noted that the time threshold can be defined manually by the operator thanks to this interface.

Alternatively or additionally, the control unit 7 determines the density of the additional sample only if the detector 9 detects the insertion of the additional sample. If the detector 9 does not detect the input of the additional sample, the control unit 7 determines the density of the sample 1a and of the one or more samples.

The operation of the densimeter 1, described above in structural terms, defines a new measurement method 10 of the density of a sample 1a, suitably of unknown weight and/or volume, comprising the densimeter 1 described above.

The measurement method, outlined in FIG. 2, comprises a set-up step 11 in which the scale 4 measures the first mass of the tank 2.

Optionally in the set-up step 11 the level indicator 5 and the measuring element 6 measure the first height of the liquid 3 in the tank 2.

Optionally, in the case of the preferred indirect measurement alternative of the change in height of the liquid 3 based on a pressure change on the level indicator 5, in the set-up step 11 the densimeter may determine a machine constant (mach. const.) such as

$$Cost . macc . = \frac{{ρ}_{l} \times {S}_{G}}{( {S}_{V} - {S}_{G} )}$$

i.e. as a function of the density of the liquid 3 and the cross-sections of the volume 2a and the level indicator 5.

It should be noted that the density of the liquid 3 and cross-sections or other physical characteristics (such as the height) of the volume 2a and level indicator 5 are unknown.

It should be noted that with the machine constant the formula for calculating the density ρₒ in the case of indirect measurement, shown above, becomes:

$${ρ}_{o} = \frac{{m}_{o}}{Δ F} \times Cost . macc .$$

The calculation of the mach. const. can be performed using a set-up sample of known density (e.g. water or cream of known density). The density of the set-up sample is entered and then made known to the densimeter 1 preferably via said densimeter-user interface. At this point any amount of set-up sample is inserted in the liquid 3 so that the scale 4 determines the weight of the set-up sample inserted, the measuring element 6 detects the pressure on the level indicator 5 and the control unit 7 determines the mach. const. based on said weight and said pressure.

After the set-up step 11, the measurement method 10 comprises, for each sample 1a, an immersion step 12 of the sample 1a in the liquid 3; a measuring step 13 in which the mass change of the tank 2 (identifying the mass of the sample 1a) and the volume of the sample 1a measured as a function of the height change of the liquid 3 are measured; and a calculation step in which the control unit 7 determines the density of the sample based on said mass change and said height change, i.e. the volume of the sample 1a.

In the immersion step 12 a sample 1a, suitably of unknown weight and volume, is inserted into the storage volume 2a and then completely immersed in the liquid 3. In the measurement step 13 the mass variation of the tank 2 can be determined as the difference between the weights/masses measured in steps 11 and 12.

Similarly, the volume of the sample 1a is measured as a function of the difference between the heights measured in steps 11 and 12 (case of direct measurement).

In the preferred indirect measurement alternative, in the measurement step 13 the volume of the sample 1a is measured as a function of the pressure variation on the level indicator 5.

The measurement step 13 and thus the density measurement of the sample 1a are described above.

It should be noted that the immersion 12, measurement 13 and calculation steps can be repeated so as to evaluate samples 1a of a different object or of the same object in sequence. This can be done without removing the previously measured sample(s) 1a using as the set-up step 11 of the new sample 1a the measurement step 13 of the previous sample 1a.

The measurement method 10 may comprise at least one additional step of immersing an additional sample in the liquid 3; at least one additional measurement step in which the mass change of the tank 2 and the height change of the liquid 3 are measured; and at least one additional calculation step in which the control unit 7 determines the density of at least the additional sample based on said mass change and said height change.

In particular, in the supplementary calculation step the control unit 7 determines the density of the supplementary sample using only the mass and height variations determined in the previous additional measurement step. Alternatively, the control unit 7 determines the density of the sample 1a and the additional sample(s) using the mass and height variations determined in the previous additional measurement step and in the one or more additional measurement step(s) prior to the same.

In particular, if the clock 8 detects a period of non-insertion substantially at least equal to a time threshold, the control unit 7 resets the previously determined weight and height variations and determines the density of the additional sample only using only the mass and height variations determined in the previous measurement step.

If the clock 8 detects a non-insertion period substantially below a time threshold, the control unit 7 does not reset the previously determined weight and height variations and determines the density of the sample 1a and the additional sample(s) subsequently introduced based on all previously calculated variations.

Alternatively or additionally, the control unit 7 determines the density of the additional sample only if the detector 9 detects the insertion of the additional sample.

If the detector 9 does not detect the insertion of the additional sample, the control unit 7 determines the density of the sample 1a and of the one or more additional samples.

The densimeter 1 according to the invention achieves important advantages.

In fact, unlike the known densimeters, the densimeter 1 and the measurement method 10 allow the density of any sample 1a to be measured in a single step with great precision, extreme speed and maximum simplicity, even if in the creamy state and therefore difficult to evaluate.

In particular, the densimeter 1 and the measurement method 10 allow the density of a sample 1a to be measured in a single step even if the sample 1a is of unknown weight and volume

Another advantage is that the density calculation is performed by directly and automatically integrating the data acquired from the densimeter 1, without the need for intervention (data entry or calculation) by the operator and above all without pre-setting known or predetermined measurements in the calculation logic.

Such aspects are possible thanks to the fact that, contrary to the prior art, the densimeter 1 and the measurement method 10 allow the density of a sample 1a to be measured in a single step reducing the possibility of error.

The aforesaid extreme precision is evidenced by the possibility of measuring multiple samples 1a of the same object by repeating steps 12 and 13 until a substantial invariance in the measured density is obtained.

Other advantages therefore lie in the objectivity of the measurement and the ease of reading it, possible simply by connecting the densimeter 1 and in particular the control unit 7 to a communication interface with an operator.

Measurement sensitivity and especially independence from external factors are other important advantages of the densimeter 1.

An important advantage is the indirect measurement of the change in height of the liquid 3 based on the change in pressure on the level indicator 5. In fact, it avoids the errors normally due to surface tension (such as those due to irregularities in the contact zone between the level indicator 5 and the liquid 3), which prevent the precise measurement of the height of the liquid 3.

Another advantage is that the adoption of the additional steps of immersion, measurement, calculation can be performed without the removal from the liquid 3 of the sample 1a previously evaluated, thereby allowing a measurement of greater accuracy with a minimum amount of material used. In fact, it is sufficient to insert small additional samples, repeating the additional steps until the density determined by the densimeter 1 changes and therefore the measurement error that the components of the densimeter 1 may comprise, have been absorbed.

Variations may be made to the invention described herein without departing from the scope of the inventive concept defined in the claims.

For example, in the additional immersion step the additional sample may be of different material from that of the sample 1a of the previous immersion step allowing the measurement of a different sample without removing the previous one and therefore with extreme speed and minimal waste.

It is to be noted in this case how, before the introduction of each of said additional samples of different material and thus before each additional immersion step, the measurement method 10 may comprise a zeroing step in which the calculation of the measured weight and height variation in the one or more previous calculation steps is reset.

For the sake of completeness it should be noted that, as is obvious to a person skilled in the art, it makes no difference performing the volume calculation with the pressure variation of the liquid 3 on the indicator 5 or with the force variation of the liquid 3 on the indicator 5. Accordingly, although not perfectly correct as regards physics, herein the term “pressure” may identify a force or pressure without any lack of clarity to a person skilled in the art.

In said sphere all the details may be replaced with equivalent elements and the materials, shapes and dimensions may be as desired.

1. A densimeter suitable to measure the density of a sample comprising
a tank defining a storage volume;
a liquid partially filling said storage volume;
a scale suitable to measure the mass of said tank;
a level indicator partially immersed in said liquid and integral with said tank so as to remain stationary upon introduction of said sample into said liquid;
a measuring element suitable to detect a pressure variation on said level indicator upon introduction of said sample;
a control unit suitable to determine the density of said sample in said liquid based on a change in mass of said tank measured by said scale and the volume of said sample measured based on said change in pressure on said level indicator.

2. The densimeter according to claim 1, wherein said liquid has a density of less than 2 g/cm3.

3. The densimeter according to claim 1, wherein said liquid has a viscosity of less than 10000 cP.

4. The densimeter according to claim 1, wherein the ratio between the cross-section of said level indicator and the cross-section of said storage volume is substantially greater than 1/20.

5. The densimeter according to claim 1, wherein the cross-section of said level indicator and the cross-section of said storage volume are substantially constant.

6. A measurement method using a densimeter to measure density of a sample; said densimeter comprising
a tank defining a storage volume;
a liquid partially filling said storage volume;
a scale suitable to measure the mass of said tank;
a level indicator partially immersed in said liquid and integral with said tank so as to remain stationary upon introduction of said sample into said liquid;
a measuring element suitable to detect a pressure variation on said level indicator upon introduction of said sample;
a control unit suitable to determine the density of a sample in said liquid
said measurement method comprising
an immersion step comprising immersing said sample in said liquid;
a measurement step in which the variation in mass of said tank and of the volume of said sample measured as a function of said pressure variation on said level indicator are measured;
a calculation step wherein said control unit determines said density of said sample in said liquid based on said volume of said sample and said variation of said mass.

7. The measurement method according to claim 1, wherein in said immersion step in said liquid a quantity of said sample of unknown volume and weight is immersed.

8. The measurement method according to claim 6, comprising
at least one additional step of immersing an additional sample in said liquid without removing said sample from said liquid;
at least one additional measuring step in which the change in mass of said tank and the change in height of said liquid in said tank caused by the immersion of said additional sample in said liquid are measured;
a further calculation step wherein said control unit determines said density of at least said additional sample in said liquid based on said variation of said mass and said variation of said height calculated in at least said additional measurement step.

9. The measurement method according to claim 8, wherein said densimeter comprises a clock suitable to detect the non-insertion period defining the time elapsed between the detection of at least one of said weight change and said height change;
wherein in said additional calculation step, if said non-insertion period is substantially at least equal to a time threshold, said control unit determines said density of only said additional sample in said liquid based on said change in said mass and said change in said height calculated exclusively in said additional measurement step; and wherein in said additional calculation step, if said non-insertion period is substantially lower than said time threshold, said control unit determines said density of said sample and said additional sample in said liquid based on said change in said mass and said change in said height calculated exclusively in said measurement step and in said additional measurement step.

10. The densimeter according to claim 2, wherein said liquid has a viscosity of less than 10000 cP.

11. The densimeter according to claim 10, wherein the ratio between the cross-section of said level indicator and the cross-section of said storage volume is substantially greater than 1/20.

12. The densimeter according to claim 10, wherein the cross-section of said level indicator and the cross-section of said storage volume are substantially constant.

13. The measurement method according to claim 7, comprising
at least one additional step of immersing an additional sample in said liquid without removing said sample from said liquid;
at least one additional measuring step in which the change in mass of said tank and the change in height of said liquid in said tank caused by the immersion of said additional sample in said liquid are measured;
a further calculation step wherein said control unit determines said density of at least said additional sample in said liquid based on said variation of said mass and said variation of said height calculated in at least said additional measurement step.

14. The measurement method according to claim 13, wherein said densimeter comprises a clock suitable to detect the non-insertion period defining the time elapsed between the detection of at least one of said weight change and said height change;
wherein in said additional calculation step, if said non-insertion period is substantially at least equal to a time threshold, said control unit determines said density of only said additional sample in said liquid based on said change in said mass and said change in said height calculated exclusively in said additional measurement step; and
wherein in said additional calculation step, if said non-insertion period is substantially lower than said time threshold, said control unit determines said density of said sample and said additional sample in said liquid based on said change in said mass and said change in said height calculated exclusively in said measurement step and in said additional measurement step.
